(19) United States
(12) Patent Application Publication
(10) Pub. No.: US 2009/0102589 A1
(43) Pub. Date: Apr. 23, 2009

(54) INDUCTOR AND CORE THEREOF

(75) Inventors: Cheng-Chang LEE, Taoyuan Hsien (TW); Zong-Ting YUAN, Taoyuan Hsien (TW); Heng-Chung CHANG, Taoyuan Hsien (TW); Huang-Kun CHEN, Taoyuan Hsien (TW); Tai-Kang SHING, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/115,092

(22) Filed: May 5, 2008

(30) Foreign Application Priority Data
Oct. 19, 2007 (TW) 96139109

(51) Int. Cl. H01F 27/255; H01F 27/02

(52) U.S. Cl. 336/83; 336/233

(57) ABSTRACT

An inductor includes a coil and a core. The core covers the coil and includes a plurality of magnetic particles. Each of the magnetic particles includes a nucleus and a first shell enveloping the nucleus. The nucleus and the first shell are formed by different materials with different specific gravities. When the nucleus includes a polymer material, the first shell includes the first magnetic material. When the nucleus includes the first magnetic material, the first shell includes the polymer material.

### BACKGROUND OF THE INVENTION

1. Field of the Invention

The invention relates to an inductor and core thereof and particularly relates to an inductor and core thereof with uniformly dispersed magnetic materials and simplified processes.

2. Description of the Related Art

The trend of science and technological development is towards improving electronic device efficiency. The key factor, however, is matching components applied in the electronic device. For example, in the case of a switching power supply, the inductor devices is the key to improving efficiency of the conventional inductor device under high frequency operation.

There are several fabricating methods for inductor devices under high frequency operation. The inductor device can be made of ferrite powders by a high temperature (higher than 800° C.) sintering technique. Alternately, the inductor device can be made of a magnetic particle mixed with a bonding agent with a proper ratio (less than 5 wt %) by a molding method under proper pressure and temperature (less than 200° C.). Furthermore, the inductor device can be fabricated by plating or sputtering and polymer coating on a semiconductor chip. However, the inductor device fabricated by high temperature sintering is difficult in being integrated with integration circuits. The inductor device fabricated by mixing the magnetic particle with a polymer material should take the dispersing degree of the magnetic particle and the polymer material into consideration. Therefore, a coupling agent must be added to the magnetic particle as a pretreatment to avoid non-uniform dispersion. However, agglomeration of the magnetic particle still can't be avoided, thereby resulting in the magnetic particle with a non-uniform aggregate size. A magnetic particle with aggregate size larger than skin depth may result in serious eddy current loss, wherein the skin depth is defined as the depth below the surface of the conductor at which the current density decays to 1/e (about 0.37) of the current density at the surface. Therefore, total efficiency of the conventional inductor device is hindered.

Thus, an inductor and core thereof with controlled aggregate size of the magnetic particle and uniform dispersion to improve total efficiency of the inductor device is needed.

### BRIEF SUMMARY OF INVENTION

It is an object of the present invention to provide an inductor and core thereof, wherein the magnetic particles inside the core have uniform aggregate size to improve the performance of the inductor under high frequency operation.

The core includes a plurality of magnetic particles, wherein each of the magnetic particles includes a nucleus and a first shell enveloping the nucleus, and the nucleus and the first shell include different materials.

The inductor includes a coil and a core, the core covers the coil and includes a plurality of magnetic particles, wherein each of the magnetic particles includes a nucleus and a first shell enveloping the nucleus, and the nucleus and the first shell include different materials.

In one embodiment, the nucleus and the first shell include different materials with different specific gravities, and the nucleus or the first shell includes a first magnetic material. The first magnetic material includes iron (Fe), silicon (Si), cobalt (Co), nickel (Ni), aluminum (Al), molybdenum (Mo), manganese (Mn) or chromium (Cr). When the nucleus includes a polymer material, the first shell includes the first magnetic material. The first shell is formed on the nucleus by a chemical plating method. The first shell is thinner than the skin depth of the first magnetic material. The first shell includes an amorphous structure or a microcrystalline structure. The polymer material includes polyvinyl chloride (PVC) or polyimide (PI).

The core further includes a second shell enveloping the first shell. The second shell includes a second magnetic material. The second magnetic material includes iron (Fe), silicon (Si), cobalt (Co), nickel (Ni), aluminum (Al), molybdenum (Mo), manganese (Mn) or chromium (Cr). The second shell is formed by a chemical plating method. The first magnetic material and the second magnetic material include different materials. When the nucleus includes the first magnetic material, the first shell includes a polymer material, and the core further includes an insulating layer between the first shell and the second shell. The insulating layer includes oxide. The oxide includes metal oxide, silicon dioxide or combinations thereof.

When the nucleus includes the first magnetic material. The first shell includes a polymer material. The polymer material includes polyvinyl chloride (PVC) or polyimide (PI). Each of the magnetic particles further includes a second shell enveloping the first shell. The second shell includes a second magnetic material. The second magnetic material includes iron (Fe), silicon (Si), cobalt (Co), nickel (Ni), aluminum (Al), molybdenum (Mo), manganese (Mn) or chromium (Cr). The second shell is made by a chemical plating method. The first and second magnetic materials include different materials.

An outer surface of each of the magnetic particles is enveloped by an outer shell. The outer shell includes an insulating material. The insulating material includes epoxy resin. The core is formed by the magnetic particles and resin. The magnetic particles are ball shaped, ball-like shaped or elliptic shaped. The core is used for an inductor. The inductor includes a choke inductor. The inductor as mentioned before is used for a switching power supply.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a sectional view showing an inductor according to a preferred embodiment of the present invention.

FIG. 2 shows a sectional view showing a magnetic particle of the present invention.

FIGS. 3A and 3B are schematic views showing two magnetic particles according to another two embodiments of the present invention.

FIG. 4 shows a schematic view of a magnetic particle according to further another embodiment of the present invention.

### DETAILED DESCRIPTION OF INVENTION

The following description is of a mode of carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer to the same or like parts.

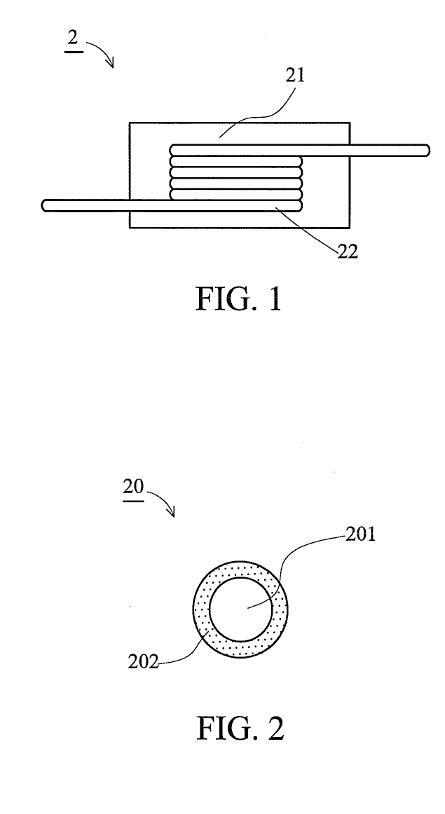

FIG. 1 shows a sectional view showing an inductor according to a preferred embodiment of the present invention. The inductor 2 of the invention, such as a choke inductor, includes a coil 22 and a core 21. The coil 22 may be a circular-shaped, square-shaped or flat-shaped wire with a plurality of windings. The core 21 covers the coil 22, and the core 21 is formed by mixing a plurality of magnetic particles with resin.

FIG. 2 shows a sectional view showing a magnetic particle of the present invention. The magnetic particle 20 of the invention includes a nucleus 201 and a first shell 202 enveloping the nucleus 201. The nucleus 201 and the first shell 202 include different materials with different specific gravities, and the nucleus 201 or the first shell 202 includes a first magnetic material. In this embodiment, the nucleus 201 includes a polymer material, for example, polyvinyl chloride (PVC) or polyimide (PI). Next, the nucleus 201 may be dispersed into a solution having a first magnetic material. The first magnetic material may include iron (Fe), silicon (Si), cobalt (Co), nickel (Ni), aluminum (Al), molybdenum (Mo), manganese (Mn), chromium (Cr) or other metal materials. A first shell 202 is then formed on an outer surface of the nucleus 201 by chemical plating with properly controlled process parameters, for example, time etc. Therefore, the ball shaped, ball-like shaped or elliptic shaped magnetic particle 20 is completely formed.

As mentioned before, the magnetic particle 20 is used to design a nucleus-shell structure including the nucleus 201 and the first shell 202 enveloping the nucleus 201. Because of the nucleus 201 is made of a polymer material with lighter specific gravity, the nucleus 201 may be uniformly dispersed in the solution having the first magnetic material during fabrication of the first shell 202. Thickness and composition of the nucleus 201 may be more effectively controlled. Eddy current loss due to non-uniform dispersion of the nucleus 201 during first shell 202 fabrication is alleviated. The variation of the inductor fabricated by the aforementioned processes can be reduced, thus facilitating a more standard fabricating process.

Additionally, during high frequency operations, the thickness of the first magnetic material may be a key factor to determining the performance of the inductor. During fabrication of the inductor of the present invention, the thickness of the first shell 202 may be properly controlled to be smaller than the skin depth of the first magnetic material under a known operating frequency and magnetic material. Therefore, the magnetic particle 20 may be totally used for magnetic conduction and reduce eddy current loss due to the overly-thick first shell 202.

In this embodiment, the first shell 202 is formed as an amorphous structure or a microcrystalline structure by above-mentioned method besides controlling the thickness of the first shell 202. Therefore, the resistivity of the shell material can be enhanced and the eddy current loss can be reduced. Additionally, the magnetic particle 20 of the invention may have better performance during high frequency operations.

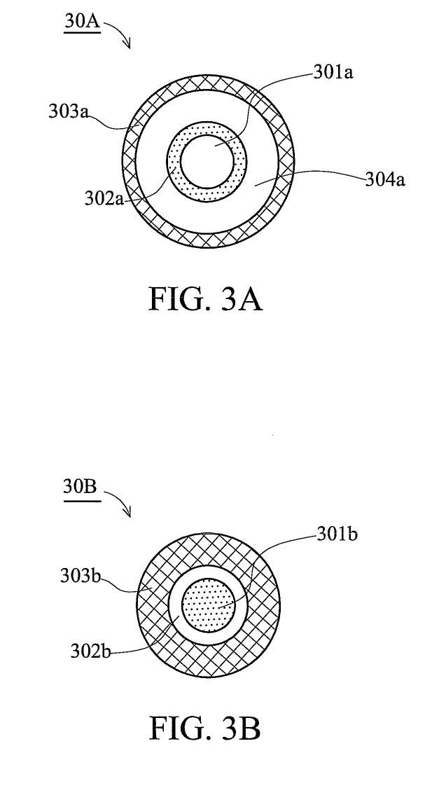

FIGS. 3A and 3B are schematic views showing two magnetic particles according to further two embodiments of the present invention. A second shell 303a may optionally envelop the first shell 302a of a magnetic particle 30A. Also, the second shell 303a may envelop the first shell 302a by a chemical plating method. The second shell 303a includes a second magnetic material. The second magnetic material may include iron (Fe), silicon (Si), cobalt (Co), nickel (Ni), aluminum (Al), molybdenum (Mo), manganese (Mn), chromium (Cr) or other metal materials. Therefore, the first magnetic material of the first shell 302a and the second magnetic material of the second shell 303a may be the same or different. For example, when the first shell 302a includes FeNiP alloy, the second shell 303a may includes FeCo alloy. However, in order to alleviate eddy current loss, an insulating layer 304a, such as oxide, is preferably formed between the first shell 302a and the second shell 303a. The oxide may include metal oxide, silicon dioxide or combinations thereof as shown in FIG. 3A. Moreover, if a nucleus 301b includes magnetic material and a first shell 302b includes polymer, no insulating layer is needed because the first magnetic material of the nucleus 301b and the second material of a second shell 303b are isolated by the first shell 302b as shown in FIG. 3B.

As mentioned before, if the magnetic particle becomes a multi-layer nucleus-shell structure, the first and second magnetic materials of the magnetic particle can be isolated from each other by an insulating layer.

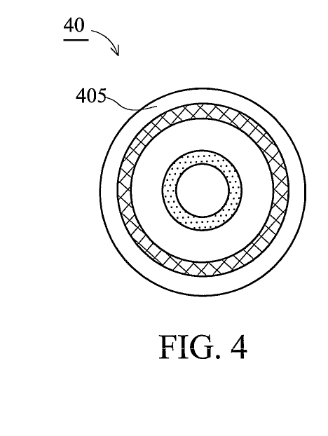

Additionally, an outer surface of each magnetic particle may be enveloped by an insulating material for increasing isolation between the magnetic particles. Referring to FIG. 4, FIG. 4 shows a schematic view showing a magnetic particle according to further another embodiment of the present invention. An outer shell 405 of the magnetic particle 40 is made of an insulating material including epoxy resin or metal oxide. Therefore, the magnetic particles 40 may not disturb each other and alleviate eddy current loss because of the isolation of the outer shells 405. The superior performances of the inductor in the embodiments of the present invention may be achieved during high frequency operations.

However, the core of the inductor 2 of the present invention may be formed not only by a single magnetic particle as shown in FIGS. 2, 3A, 3B and FIG. 4, but also by mixing various magnetic particles as shown in FIGS. 2 and 3A. The mixing ratio is dependent on the conditions.

The magnetic particle of the inductor 2, such as a choke inductor, includes a polymer material with lighter specific gravity, and therefore may be easily floated in a solution including a polymer bonding agent, for example, resin when mixing the magnetic particle with the solution. Therefore, over-sized particles by gathering may not be formed. By controlling thickness of the magnetic material during chemical plating may further alleviate eddy current loss. Under high frequency operation, the efficiency of the inductor, for example, applicable for switching power supplies, may be further improved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A core comprising:
a plurality of magnetic particles, wherein each of the magnetic particles comprises a nucleus and a first shell enveloping the nucleus, and the nucleus and the first shell comprise different materials.

2. The core as claimed in claim 1, wherein when the first shell comprises a first magnetic material, the nucleus comprises a polymer material; or when the nucleus comprises the first magnetic material, and the first shell comprises the polymer material.

3. The core as claimed in claim 2, wherein the first magnetic material comprises iron (Fe), silicon (Si), cobalt (Co), nickel (Ni), aluminum (Al), molybdenum (Mo), manganese (Mn) or chromium (Cr).

4. The core as claimed in claim 2, wherein the polymer material comprises polyvinyl chloride (PVC) or polyimide (PI).

5. The core as claimed in claim 2, wherein a thickness of the first shell is thinner than a skin depth of the first magnetic material.

6. The core as claimed in claim 2, wherein the first shell comprises an amorphous structure or a microcrystalline structure.

7. The core as claimed in claim 2, wherein each of the magnetic particles further comprises a second shell enveloping the first shell.

8. The core as claimed in claim 7, wherein the second shell comprises a second magnetic material, and the second magnetic material comprises iron (Fe), silicon (Si), cobalt (Co), nickel (Ni), aluminum (Al), molybdenum (Mo), manganese (Mn) or chromium (Cr).

9. The core as claimed in claim 8, wherein the first or second shell is formed by a chemical plating method.

10. The core as claimed in claim 8, further comprising an insulating layer between the first shell and the second shell, and the insulating layer comprises oxide, metal oxide, silicon dioxide or a combination thereof.

11. The core as claimed in claim 1, wherein an outer surface of each of the magnetic particles is covered by an outer shell, and the outer shell comprises an insulating material or epoxy resin.

12. The core as claimed in claim 1, further comprising resin mixed with the magnetic particles.

13. The core as claimed in claim 1, wherein the first shell has a specific gravity different from that of the nucleus.

14. An inductor, comprising:
a coil; and
a core covering the coil and comprising a plurality of magnetic particles, wherein each of the magnetic particles comprises a nucleus and a first shell around the nucleus, and the nucleus and the first shell comprise different materials.

15. The inductor as claimed in claim 14, wherein the inductor is a choke inductor applicable for a switching power supply.

16. The inductor as claimed in claim 14, wherein the coil comprises a circular-shaped, square-shaped or flat-shaped wire with a plurality of windings.

17. The core as claimed in claim 14, wherein when the first shell comprises a first magnetic material, the nucleus comprises a polymer material; or when the nucleus comprises the first magnetic material, and the first shell comprises the polymer material.

18. The core as claimed in claim 17, wherein the first magnetic material comprises iron (Fe), silicon (Si), cobalt (Co), nickel (Ni), aluminum (Al), molybdenum (Mo), manganese (Mn) or chromium (Cr), and the polymer material comprises polyvinyl chloride (PVC) or polyimide (PI).

19. The core as claimed in claim 17, wherein the first shell comprises an amorphous structure or a microcrystalline structure.

20. The core as claimed in claim 17, wherein each of the magnetic particles further comprises a second shell enveloping the first shell, and the second shell comprises a second magnetic material, and the second magnetic material comprises iron (Fe), silicon (Si), cobalt (Co), nickel (Ni), aluminum (Al), molybdenum (Mo), manganese (Mn) or chromium (Cr).

21. The core as claimed in claim 14, wherein the first shell has a specific gravity different from that of the nucleus.

22. The core as claimed in claim 20, further comprising an insulating layer between the first shell and the second shell, and the insulating layer comprises oxide, metal oxide, silicon dioxide or a combination thereof.

23. The core as claimed in claim 14, wherein an outer surface of each of the magnetic particles is covered by an outer shell, and the outer shell comprises an insulating material or epoxy resin.
